(19) United States
(12) Patent Application Publication
(10) Pub. No.: US 2024/0192463 A1
(43) Pub. Date: Jun. 13, 2024

(54) ZOOM LENS AND IMAGING DEVICE

(71) Applicant: ZHONGSHAN UNION OPTECH RESEARCH INSTITUTE CO., LTD., Zhongshan (CN)

(72) Inventors: Junqiang GONG, Zhongshan (CN); Hui LIU, Zhongshan (CN); Shengping QIU, Zhongshan (CN); Kun LI, Zhongshan (CN); Yang WU, Zhongshan (CN); Meijiao ZHAO, Zhongshan (CN); Cheng GE, Zhongshan (CN)

(73) Assignee: ZHONGSHAN UNION OPTECH RESEARCH INSTITUTE CO., LTD., Zhongshan (CN)

(21) Appl. No.: 18/527,808

(22) Filed: Dec. 4, 2023

(30) Foreign Application Priority Data
Dec. 8, 2022 (CN) 202211592814.X

(51) Int. Cl. G02B 7/10; G02B 7/02

(52) U.S. Cl. CPC G02B 7/102; G02B 7/021

(57) ABSTRACT

Disclosed are a zoom lens and an imaging device. An optical axis is formed within the zoom lens, the zoom lens is provided with an object side and an image side opposite to the object side along an optical axis direction, the zoom lens includes a base, a fixed lens assembly, a moving lens assembly and a linear magnetic drive structure, the fixed lens assembly is mounted on the base, the fixed lens assembly includes a first fixed lens group and a second fixed lens group provided at intervals along the optical axis direction, the moving lens assembly is movably mounted on the base along the optical axis direction, and the moving lens assembly includes a first moving lens group and a second moving lens group provided at intervals along the optical axis direction.

### CROSS-REFERENCE TO RELATED APPLICATIONS

This application claims priority to Chinese Patent Application No. 202211592814.X, filed on Dec. 8, 2022, the content of which is incorporated herein by reference in its entirety.

### TECHNICAL FIELD

The present application relates to the technical field of zoom lens, and particularly relates to a zoom lens and an imaging device.

### BACKGROUND

With the development of science and technology, people pay more and more attention to the quality of photography, and cell phones usually use the telescopic lens barrel to realize the zoom when shooting, however, the traditional zoom lens is usually provided with screws for transmission to convert the rotation of the drive motor into a straight-line movement, so as to drive the zoom lens for zoom. Since a transmission structure needs to be set up for conversion, the moving parts in the zoom lens move relatively slowly, thus the zoom process of the zoom lens spends too much time.

### SUMMARY

The main purpose of the present application is to provide a zoom lens and an imaging device, aiming at solving the problem that the zoom process of the existing zoom lens spends too much time.

In order to realize the above object, the present application proposes a zoom lens, an optical axis is formed within the zoom lens, the zoom lens is provided with an object side and an image side opposite to the object side along an optical axis direction, the zoom lens includes:
a base,
a fixed lens assembly mounted on the base, and the fixed lens assembly includes a first fixed lens group and a second fixed lens group provided at intervals along the optical axis direction,
a moving lens assembly movably mounted on the base along the optical axis direction, and the moving lens assembly includes a first moving lens group and a second moving lens group provided at intervals along the optical axis direction; and
a linear magnetic drive structure provided on the base and driven to connect the moving lens assembly;
the first fixed lens group, the first moving lens group, the second fixed lens group and the second moving lens group are arranged in sequence along the object side to the image side.

In an embodiment, the base includes:
a lower mounting plate, the linear magnetic drive structure being provided at the lower mounting plate;
an upper mounting plate provided apart from the lower mounting plate along up and down, and the fixed lens assembly being provided at the upper mounting plate; and
a plurality of support columns provided between the upper mounting plate and the lower mounting plate.

In an embodiment, the base further includes an alignment reference plate extending up and down, the alignment reference plate is provided with an alignment reference surface, the upper mounting plate is provided at an upper end of the alignment reference surface, and the lower mounting plate is provided at a lower end of the alignment reference surface.

In an embodiment, both the first moving lens group and the second moving lens group include a moving lens group; and
the moving lens assembly further includes a connecting seat extending up and down, and both ends of the connecting seat are respectively provided at the linear magnetic drive structure and the moving lens group.

In an embodiment, the connecting seat is detachably mounted to the linear magnetic drive structure and/or the moving lens group.

In an embodiment, the zoom lens further includes an infrared assembly provided at the base, and the infrared assembly is provided between the second moving lens group and the image side.

In an embodiment, the zoom lens further includes a displacement sensor provided at the base for detecting a position of the first moving lens group and a position of the second moving lens group.

In an embodiment, the linear magnetic drive structure includes a motor guide rail provided at the base; a stator structure provided at the motor guide; and a mover structure configured to move along the optical axis direction relative to the stator structure. The moving lens group is provided at the mover structure.

In an embodiment, two linear magnetic drive structure are provided, and the two linear magnetic drive structures are respectively driven to connect the first moving lens group and the second moving lens group.

In addition, the present application further provides an imaging device including the zoom lens as described above.

In the technical solution of the present application, by providing the base for mounting the fixed lens assembly and the moving lens assembly within the zoom lens, the linear magnetic drive structure are driven to connect the first moving lens group to move the first moving lens group along the optical axis direction, so as to adjust the position of the first moving lens group, and thereby adjusting the magnification of the zoom lens. The linear magnetic drive structure are driven to connect the second moving lens group to move the second moving lens group along the optical axis direction, so as to adjust the position of the second moving lens group, thereby adjusting the focusing position of the zoom lens, so that the focus of the zoom lens can fall on an imaging element. In this way, compared with the structure of the existing drive motor driving ball screw, driving the moving lens assembly by the linear magnetic drive structure, the intermediate screw transmission structure is canceled, the structure of the zoom lens is simplified and it is help to reduce the weight and volume of the zoom lens. Secondly, the linear magnetic drive structure can be directly transmission, which can eliminate various positioning errors caused by the intermediate links and help to improve the positioning accuracy of the first moving lens group and the second moving lens group. In addition, since the moving parts in the linear magnetic drive structure are supported by magnetic force, a certain gap is always maintained between the fixed parts and the moving parts in the linear magnetic drive structure without contact, on one hand, the frictional resistance between the fixed parts and the moving parts can be eliminated, which helps to improve the reaction speed and movement speed of the first moving lens group and the second moving lens group, and on the other hand, realizing the contactless force transmission between the fixed parts and the moving parts, eliminating the mechanical friction loss of the linear magnetic drive structure, effectively reducing the failure rate of the zoom lens, and helping to improve the service life of the zoom lens.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those of ordinary skill in the art.

FIG. 1 is a three-dimensional structural schematic view of a zoom lens according to an embodiment of the present application from a perspective.

FIG. 2 is a three-dimensional structural schematic view of the zoom lens of FIG. 1 from a perspective.

FIG. 3 is a three-dimensional structural schematic view of an upper mounting plate of FIG. 1.

FIG. 4 is a three-dimensional structural schematic view of a fixed lens assembly and a moving lens assembly of FIG. 1.

FIG. 5 is a three-dimensional structural schematic view of a linear magnetic drive structure of FIG. 1.

FIG. 6 is a three-dimensional structural schematic view of an imaging assembly of FIG. 1.

FIG. 7 is a three-dimensional structural schematic view of a protective cover of FIG. 1.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in this application, all other embodiments obtained by a person of ordinary skill in the art without making creative labor fall within the scope of this application.

It should be noted that, if there are directional instructions involved in the embodiments of the present application, the directional indications are only used to explain the relative positional relationship, movement and so on between various components in a specific posture. If the specific posture changes, the directional indication will also change accordingly.

In addition, in the embodiments of the present application, if there are descriptions involving “first”, “second” or the like, the descriptions of “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features. In addition, the technical solutions of various embodiments can be combined with each other, but it must be based on that those of ordinary skill in the art can realize. When the combination of technical solutions is contradictory or cannot be realized, it should be considered that such combination of technical solutions does not exist and is not within the protection scope claimed by the present application.

With the development of science and technology, people pay more and more attention to the quality of photography, and cell phones usually use the telescopic lens barrel to realize the zoom when shooting, however, the traditional zoom lens is usually provided with screws for transmission to convert the rotation of the drive motor into a straight-line movement, so as to drive the zoom lens for zoom. Since a transmission structure needs to be set up for conversion, the moving parts in the zoom lens move relatively slowly, thus the zoom process of the zoom lens spends too much time.

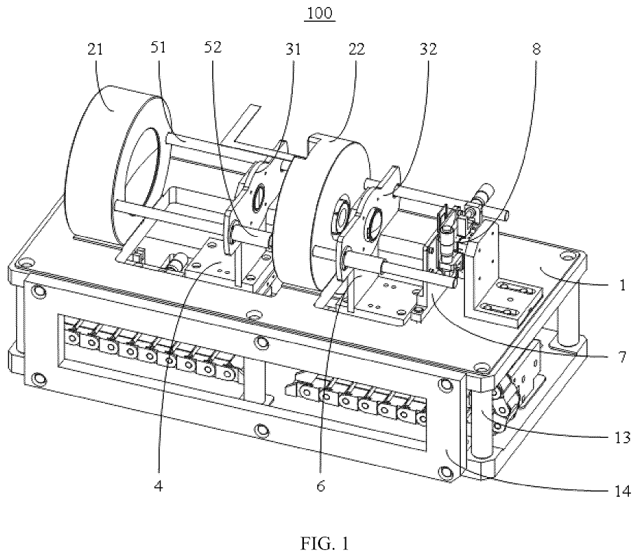

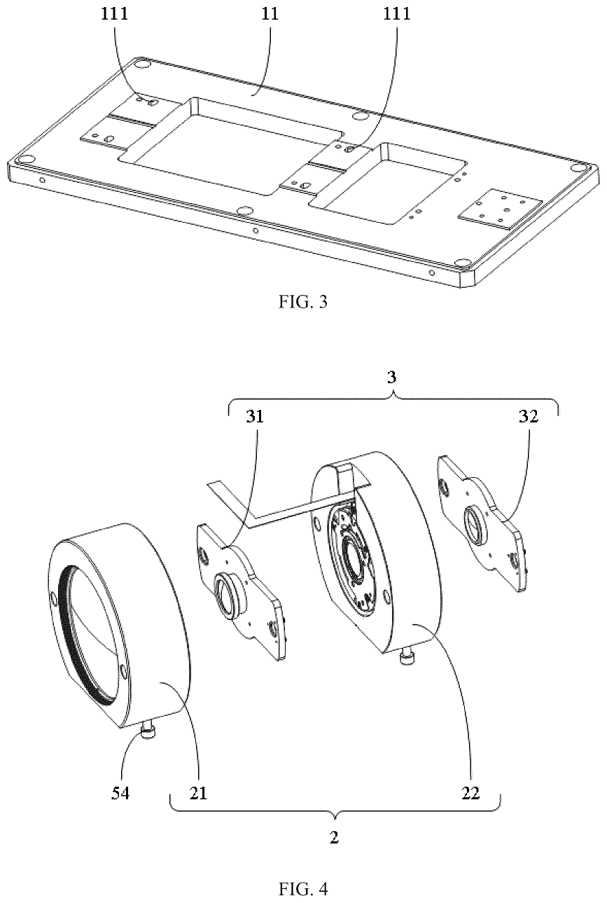

In view of the above, the present application provides a zoom lens, aiming at solving the problem that the zoom process of the existing zoom lens spends too much time. FIG. 1 to FIG. 7 show structure schematic views of a zoom lens according to an embodiment of the present application.

Referring to FIG. 1 to FIG. 4, an optical axis is formed within the zoom lens 100, the zoom lens 100 is provided with an object side and an image side opposite to the object side along an optical axis direction, the zoom lens includes a base 1, a fixed lens assembly 2, a moving lens assembly 3 and a linear magnetic drive structure 4. The fixed lens assembly 2 is mounted on the base 1, the fixed lens assembly includes a first fixed lens group 21 and a second fixed lens group 22 provided at intervals along the optical axis direction, the moving lens assembly 3 is movably mounted on the base 1 along the optical axis direction, the moving lens assembly 3 includes a first in moving lens group 31 and a second moving lens group 32 provided at intervals along the optical axis direction; the linear magnetic drive structure 4 is provided on the base 1 and driven to connect the moving lens assembly 3; and the first fixed lens group 21, the first moving lens group 31, the second fixed lens group 22 and the second moving lens group 32 are arranged in sequence along the object side to the image side.

In the technical solution of the present application, by providing the base 1 for mounting the fixed lens assembly 2 and the moving lens assembly 3 within the zoom lens 100, the linear magnetic drive structure 4 are driven to connect the first moving lens group 31 to move the first moving lens group 31 along the optical axis direction, so as to adjust the position of the first moving lens group 31, thereby adjusting the magnification of the zoom lens 100; the linear magnetic drive structure 4 are driven to connect the second moving lens group 32 to move the second moving lens group 32 along the optical axis direction, so as to adjust the position of the second moving lens group 32, thereby adjusting the focusing position of the zoom lens 100, so that the focus of the zoom lens 100 can fall on an imaging element. In this way, compared with the existing structure of the drive motor driving ball screw, driving the moving lens assembly 3 by the linear magnetic drive structure 4, the intermediate screw transmission structure is canceled, the structure of the zoom lens 100 is simplified and it is helpful to reduce the weight and volume of the zoom lens 100. Secondly, the linear magnetic drive structure 4 can be directly transmission, which can eliminate various positioning errors caused by the intermediate links and help to improve the positioning accuracy of the first moving lens group 31 and the second moving lens group 32. In addition, since the moving parts in the linear magnetic drive structure 4 are supported by magnetic force, a certain gap is always maintained between the fixed parts and the moving parts in the linear magnetic drive structure 4 without contact, on one hand, the frictional resistance between the fixed parts and the moving parts can be eliminated, which helps to improve the reaction speed and movement speed of the first moving lens group 31 and the second moving lens group 32, and on the other hand, realizing the contactless force transmission between the fixed parts and the moving parts, eliminating the mechanical friction loss of the linear magnetic drive structure, effectively reducing the failure rate of the zoom lens 100, and helping to improve the service life of the zoom lens 100.

It is to be noted that the number of lenses in the first fixed lens group 21, the second fixed lens group 22, the first moving lens group 31 and the second moving lens group 32 may be one or more than one, and the present application is not limited thereto.

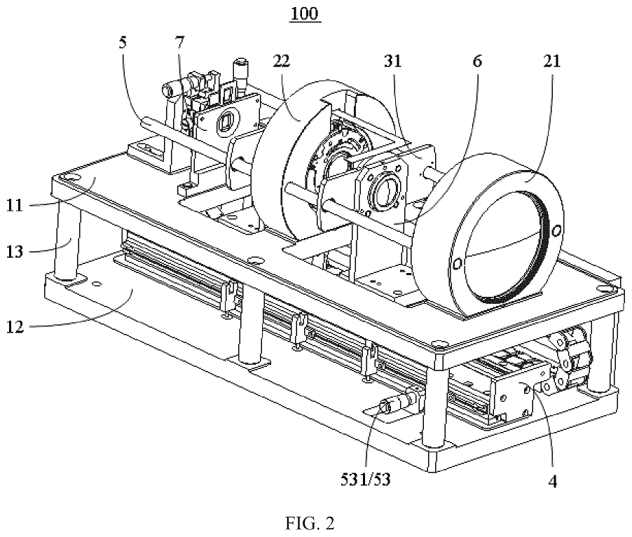

Furthermore, referring to FIG. 1 and FIG. 2, the base 1 includes a lower mounting plate 12, an upper mounting plate 11 and a plurality of support columns 13, the linear magnetic drive structure 4 being provided at the lower mounting plate 12, the upper mounting plate 11 is provided apart from the lower mounting plate 12 along up and down, and the fixed lens assembly 2 being provided at the upper mounting plate 11; and the plurality of support columns 13 are provided between the upper mounting plate 11 and the lower mounting plate 12. In this way, by setting the upper mounting plate 11 and the lower mounting plate 12, the fixed lens assembly 2 and the linear magnetic drive structure 4 are provided apart up and down, so as to utilize the space of the base 1 to improve the space utilization of the zoom lens 100 and help to reduce the volume of the zoom lens 100. Furthermore, a plurality of the support columns 13 are connected to the upper mounting plate 11 and the lower mounting plate 12 by bolted connection structures to facilitate the adjustment of the levelness of the upper mounting plate 11.

It can be understood that the fixed lens assembly 2 is connected to the upper mounting plate 11 or the lower mounting plate 12 in a variety of ways, the fixed lens assembly 2 may be fixed to the upper mounting plate 11 or the lower mounting plate 12 by adhesive bonding, the fixed lens assembly 2 can also be screwed and fixed to the upper mounting plate 11 or the lower mounting plate 12, and the present application is not limited thereto. Specifically, in this embodiment, the fixed lens assembly 2 is detachably mounted to the upper mounting plate 11 and/or the lower mounting plate 12.

Since the linear magnetic drive structure 4 passes through the upper mounting plate 11 for the moving lens assembly 3, it is necessary to make the hole of the upper mounting plate 11 align with the linear magnetic drive structure 4, based on which, in this embodiment, the base 1 further includes an alignment reference plate 14 extending up and down, the alignment reference plate 14 is provided with an alignment reference surface, the upper mounting plate 11 is provided at an upper end of the alignment reference surface, and the lower mounting plate 12 is provided at a lower end of the alignment reference surface. In this way, by setting the alignment reference plate 14, both the upper mounting plate 11 and the lower mounting plate 12 are located at the alignment reference surface, thereby enabling the hole in the upper mounting plate 11 to be aligned with the linear magnetic drive structure 4, and by providing the alignment reference plate 14 to connect the side end of the upper mounting plate 11 and the side end of the lower mounting plate 12, the connection between the upper mounting plate 11 and the lower mounting plate 12 can be strengthen, thus contributing to enhance the solidity of the base 1.

In order to connect the moving lens assembly 3 and the linear magnetic drive structure 4, in this embodiment, referring to FIG. 1 to FIG. 4, both the first moving lens group 31 and the second moving lens group 32 include a moving lens group; the moving lens assembly 3 further includes a connecting seat 6 extending up and down, and both ends of the connecting seat 6 are respectively provided at the linear magnetic drive structure 4 and the moving lens group. In this way, the connecting seat 6 passes through the upper mounting plate 11 to connect the linear magnetic drive structure 4 with the first moving lens group 31 and the second moving lens group 32, so that the linear magnetic drive structure 4 can directly drive the first moving lens group 31 and the second moving lens group 32, so as to quickly adjust the positions of the first movable lens group 31 and the second movable lens group 32.

The connecting seat 6 is connected to the linear magnetic drive structure 4 and the moving lens group in various ways, the connecting seat 6 may be fixedly connect to the linear magnetic drive structure 4 and the moving lens group by welding, or may be detachably connected to the linear magnetic drive structure 4 and the moving lens group by bolt, to which the present application is not limited. Specifically, in this embodiment, the connecting seat 6 is detachably mounted to the linear magnetic drive structure 4 and/or the moving lens group. In this way, by employing a detachable connection, on the one hand, being able to replace the connecting seat 6 as required to make the connecting seat 6 adapt the spacing between the moving lens group and the linear magnetic drive structure 4, on the other hand, it is convenient to subsequently set up an adjusting structure between the connecting seat 6 and the linear magnetic drive structure 4 or the moving lens group to adjust the inclination and levelness of the moving lens group.

In order to enable the zoom lens 100 to adapt to changes in the external environment, in this embodiment, the zoom lens 100 further includes an infrared assembly 7 provided at the base 1, and the infrared assembly 7 is provided between the second moving lens group 32 and the image side, so that when the zoom lens 100 is in a dark environment, infrared light is allowed to pass through, thus the imaging element of the zoom lens 100 can recognize infrared light, and when the zoom lens 100 is in a bright environment, visible light is allowed to pass through and infrared light is blocked from passing through, thus the imaging element of the zoom lens 100 can recognize visible light. In this way, by switch of the infrared assembly 7, the zoom lens 100 can be used in both bright environment and dark environment, thereby making the zoom lens 100 adaptable to changes in the external environment.

In order to precisely adjust the moving position of the moving lens assembly 3, in this embodiment, the zoom lens 100 further includes a displacement sensor provided at the base 1 for detecting a position of the first moving lens group 31 and a position of the second moving lens group 32. In this way, by setting the displacement sensor to detect the positions of the first moving lens group 31 and the position of the second moving lens group 32, so as to cooperate with the control program of the zoom lens 100 to precisely control the moving position of the first moving lens group 31 and the second moving lens group 32, thereby contributing to improve the accuracy of the zoom lens 100. It can be understood that one displacement sensor can be set, or multiple displacement sensors can be set corresponding to the moving lens assembly 3, and the present application is not limited thereto.

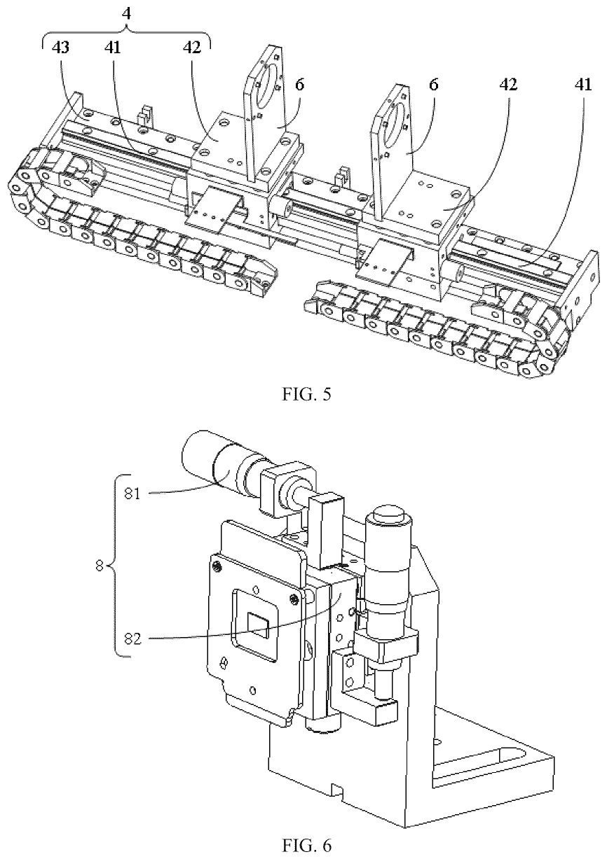

In order to drive the first moving lens group 31 and the second moving lens group 32 to move, in this embodiment, referring to FIG. 5, the linear magnetic drive structure 4 includes a motor guide rail 41, a stator structure 43 and a mover structure 42, the motor guide rail 41 is provided at the base 1, the stator structure 43 is provided at the motor guide 41, the mover structure 42 is configured to move along the optical axis direction relative to the stator structure 43; and the moving lens group is provided at the mover structure 42. In this way, driving the stator structure 43 and the mover structure 42 by mutual magnetism to enable the mover structure 42 to be movable relative to the stator structure 43, and providing the motor guide rail 41 to move the mover structure 42 in a straight line, thereby driving the first moving lens group 31 and the second moving lens group 32 to move in a straight line.

Since the first moving lens group 31 and the second moving lens group 32 are driven by the linear magnetic drive structure 4, if the linear magnetic drive structure 4 is driven in a direction that is offset from the optical axis direction, it will cause that the position of the first moving lens group 31 and the position of the second movable lens group 32 are offset when moving, and for this reason, in this embodiment, the zoom lens 100 includes a motor adjusting structure 53, the motor adjusting structure 53 includes a horizontal adjusting structure 531, the horizontal adjusting structure 531 includes a first micrometer structure, the first micrometer structure including a first fixed end and a first moving end provided relatively movable, the first fixed end is provided at the base 1, the first moving end is abutted against the side end of the motor guide rail 41 to adjust the position of the motor guide rail 41 in the horizontal direction. In this way, by setting the first micrometer structure to adjust the position of the linear magnetic drive structure 4, so that the driving direction of the linear magnetic drive structure 4 is parallel to the optical axis direction, thereby ensuring that the positions of the first moving lens group 31 and the second moving lens when moving will not deviate from the optical axis.

In order to adjust the levelness of the linear magnetic drive structure 4, in this embodiment, the first height adjusting structure includes a plurality of a first adjusting shims, the first adjusting shims of different thicknesses and/or quantities are selected and arranged between the base 1 and the motor guide rail 41 to adjust the height of the motor guide rail 41. In this way, by adjusting the number and thickness of the first adjusting shims to adjust the levelness of the linear magnetic drive structure 4, so as to prevent the first moving lens group 31 and the second moving lens group 32 from deviating from the height at which the optical axis is located when moving, thereby ensuring that the positions of the first moving lens group 31 and the second moving lens group 32 when moving will not deviate from the optical axis.

The number of the linear magnetic drive structure 4 is not limited, the linear magnetic drive structure 4 can be one, or can be multiple corresponding to the moving lens assembly 3, and the present application is not limited thereto. Two linear magnetic drive structure are provided, and the two linear magnetic drive structures 4 are respectively driven to connect the first moving lens group 31 and the second moving lens group 32. In this way, by providing two linear magnetic drive structures 4 to respectively drive the first moving lens group 31 and the second moving lens group 32 to move, thereby avoiding mutual influence between the first moving lens group 31 and the second moving lens group 32.

In order to align the center of the first fixed lens group 21, the center of the second fixed lens group 22, the center of the first moving lens group 31 and the center of the second moving lens group 32, specifically, referring to FIG. 1, FIG. 2 and FIG. 4, the zoom lens 100 further includes a center alignment structure 5, the center alignment structure 5 is configured to reduce the alignment deviation of the center axis of at least two of the first fixed lens group 21, the first moving lens group 31, the second fixed lens group 22 and the second moving lens group 32. In this way, by providing the center alignment structure 5, it not only aligns the center of the first fixed lens group 21, the center of the first moving lens group 31, the center of the second fixed lens group 22 and the center of the second moving lens group 32, but also ensures that the center of the first moving lens group 31 and the center of the second moving lens group 32 will not deviate from the optical axis when moving.

Furthermore, two guide shafts 51 are passed through the two moving lens group and the two fixed lens group, the two guide shafts 51 are provided apart horizontally, the two moving lens groups are both provided with guide bushings 52, each guide bushings 52 is movably sleeved on the corresponding guide shaft 51, the center alignment structure 5 includes the guide shaft 51 and the guide bushing 52. When it is necessary to correct the center of the first fixed lens group 21, the center of the second fixed lens group 22, the center of the first moving lens group 31 and the center of the second moving lens group 32, firstly, two guide shafts 51 are passed through the first fixed lens group 21, the second fixed lens group 22, the first moving lens group 31 and the second moving lens group 32, secondly, connecting the guide bushing 52 with the first moving lens group 31 and the second moving lens group 32 to hang the upper end of the first moving lens group 31 and the upper end of the second moving lens group 32 on the guide shaft 51, and then adjusting the spacing among the first moving lens group 31, the second moving lens group 32 and the linear magnetic drive structure 4. In this way, by providing two guide shafts 51 to align the center of the fixed lens assembly 2 with the center of the moving lens assembly 3, on the other hand, the moving directions of the first moving lens group 31 and the second moving lens group 32, thereby preventing the position from deviating when the first moving lens group 31 and the second moving lens group 32 are moving, thus the center of the first fixed lens group 21, the center of the second fixed lens group 22, the center of the first moving lens group 31 and the center of the second moving lens group 32 are all on the optical axis, at the same time, by providing the guide bushing 52, the first moving lens group 31 or the second moving lens group 32 can be hung on the two guide shafts 51 to ensure that the center of the first moving lens group 31 and the center of the second moving lens group 32 will not deviate from the optical axis when moving.

It is to be noted that there are various kinds of center alignment structure 5, any structure capable of aligning the centers of the first fixed lens group 21, the first moving lens group 31, the second fixed lens group 22 and the second moving lens group 32 is within the scope of the present application. Specifically, in another embodiment, in the first fixed lens group 21, the first moving lens group 31, the second fixed lens group 22 and the second moving lens group 32, an alignment rod is provided between two adjacent lens groups. In this way, by providing a plurality of alignment rods, the adjacent lens groups are aligned two by two respectively, so that the center of the first fixed lens group 21, the center of the first moving lens group 31, the center of the second fixed lens group 22 and the center of the second moving lens group 32 are aligned.

Furthermore, the center alignment structure 5 further includes a second height adjusting structure, the second height adjusting structure includes a plurality of a second adjusting shims, the second adjusting shims of different thicknesses and/or quantities are selected and arranged between the moving lens group and the mover structure 42 to adjust the height of the moving lens group. In this way, by adjusting the number and thickness of the second adjusting shims, so that when the upper end of the first moving lens group 31 or the upper end of the second moving lens group 32 is fixed, making the spacing among the second adjusting shim, the linear magnetic drive structure 4, the first moving lens group 31 and the second moving lens group 32 being adapted to each other, so as to cooperate with the guide bushing 52 to adjust the deviation of the center of the first moving lens group 31 or the center of the second moving lens group 32 from the optical axis, thereby ensuring that the position of the first moving lens group 31 and the position of the second moving lens group 32 when moving will not deviate from the optical axis.

Since the guide shaft 51 and the guide bushing 52 are both made of metal and have a heavy weight, and do not need to remain in alignment after the first moving lens group 31 and the second moving lens group 32 have completed alignment, for this reason, in this embodiment, the guide bushing 52 is detachably mounted to the corresponding moving lens group, thus, a detachable connection is employed to facilitate the mounting and dismounting of the guide bushing 52, so as to remove the guide bushing 52 after completing the center alignment of the first moving lens group 31 or the second moving lens group 32, thereby contributing to reducing the weight of the zoom lens 100.

It can be understood that there are various ways of connection between the guide bushing 52 and the moving lens group, the guide bushing 52 and the moving lens group may be connected by welding, or by a threaded connection structure and so on, and the present application is not limited thereto.

Since there may be a deviation in the center of the first fixed lens group 21, the center of the second fixed lens group 22, the center of the first moving lens group 31 and the center of the second moving lens group 32, in order to keep the center of the first fixed lens group 21, the center of the second fixed lens group 22, the center of the first moving lens group 31 and the center of the second moving lens group 32 consistent, in this embodiment, the upper end of the base 1 is provided with a strip hole 111 extending along a direction perpendicular to the optical axis direction, the center alignment structure 5 further includes a mounting column 54 provided at the lower end of the fixed lens group, the mounting column 54 is provided in the strip hole 111, and its position in the strip hole 111 is adjustable. In this way, by setting the strip hole 111 to adjust the position of the first fixed lens group 21 and the position of the second fixed lens group 22, it is helpful to make the center of the first fixed lens group 21 and the center of the second fixed lens group 22 locate on the optical axis.

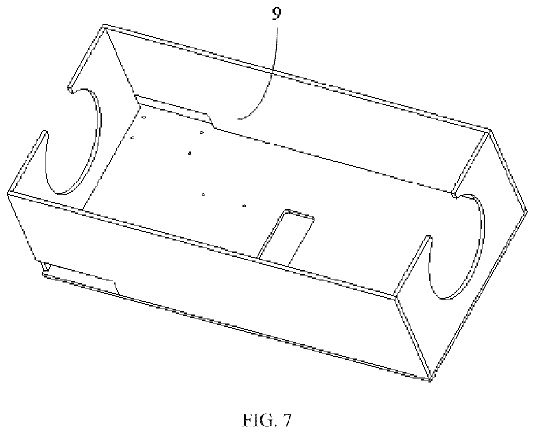

In order to make the imaging element be on the optical axis, in this embodiment, referring to FIG. 6, the zoom lens 100 further includes an imaging assembly 8, the imaging assembly 8 includes a sliding seat 81 and a second micrometer structure 82, the sliding seat 81 is movably mounted to the base 1 along the direction perpendicular to the optical axis direction for installation of the imaging element, the second micrometer structure 82 includes a second fixed end and a second fixed end provided relatively movable, the second fixed end is provided at the base 1, the second moving end is abutted against the side end of the sliding seat 81 to adjust the position of the sliding seat 81. In this way, by setting the second micrometer structure to adjust the position of the sliding seat 81, thereby adjusting the position of the imaging element, so that the center of the imaging element is positioned on the optical axis, so that the focus of the zoom lens can fall on the imaging element.

In order to protect the first fixed lens group 21, the first moving lens group 31, the second fixed lens group 22 and the second moving lens group 32, in this embodiment, referring to FIG. 7, the zoom lens 100 further includes a protective cover 9 provided at the upper end of the base 1. In this way, by providing a protective cover 9 to protect the first moving lens group 31 and the second moving lens group 32, thereby preventing other structures from entering inside the protective cover 9 and colliding with the first moving lens group 31 or the second moving lens group 32, thus helping to protect the lens group in the zoom lens 100.

In addition, to accomplish the above purpose, the present application further provides an imaging device, the imaging device including a zoom lens 100 as described above. It is to be noted that the structure of the zoom lens 100 in the imaging device can be referred to the above embodiment of the zoom lens 100, which will not be repeated herein. Since the above-mentioned zoom lens 100 is used in the imaging device provided by the present application, the embodiments of the imaging device provided by the present application include all the technical solutions of all the embodiments of the above-mentioned zoom lens 100, and the technical effects achieved are exactly the same, which will not be repeated herein.

The above are only some embodiments of the present application, and are not intended to limit the scope of the present application. Under the concept of the present application, any equivalent structure transformation made by using the description and accompanying drawings of the present application, or directly or indirectly applied in other related technical fields, is included within the scope of the present application.

What is claimed is:

1. A zoom lens, wherein an optical axis is formed within the zoom lens, the zoom lens is provided with an object side and an image side opposite to the object side along an optical axis direction, the zoom lens comprises:
a base,
a fixed lens assembly mounted on the base, wherein the fixed lens assembly comprises a first fixed lens group and a second fixed lens group provided at intervals along the optical axis direction,
a moving lens assembly movably mounted on the base along the optical axis direction, wherein the moving lens assembly comprises a first moving lens group and a second moving lens group provided at intervals along the optical axis direction; and
a linear magnetic drive structure provided on the base and driven to connect the moving lens assembly,
wherein the first fixed lens group, the first moving lens group, the second fixed lens group and the second moving lens group are arranged in sequence along the object side to the image side.

2. The zoom lens according to claim 1, wherein the base comprises:
a lower mounting plate, the linear magnetic drive structure being provided at the lower mounting plate;
an upper mounting plate provided apart from the lower mounting plate along up and down, the fixed lens assembly being provided at the upper mounting plate; and
a plurality of support columns provided between the upper mounting plate and the lower mounting plate.

3. The zoom lens according to claim 2, wherein the base further comprises an alignment reference plate extending up and down, the alignment reference plate is provided with an alignment reference surface, the upper mounting plate is provided at an upper end of the alignment reference surface, and the lower mounting plate is provided at a lower end of the alignment reference surface.

4. The zoom lens according to claim 1, wherein:
both the first moving lens group and the second moving lens group comprise a moving lens group; and
the moving lens assembly further comprises a connecting seat extending up and down, and both ends of the connecting seat are respectively provided at the linear magnetic drive structure and the moving lens group.

5. The zoom lens according to claim 4, wherein the connecting seat is detachably mounted to the linear magnetic drive structure and/or the moving lens group.

6. The zoom lens according to claim 5, wherein the zoom lens further comprises an infrared assembly provided at the base, and the infrared assembly is provided between the second moving lens group and the image side.

7. The zoom lens according to claim 1, further comprising:
a displacement sensor provided at the base for detecting a position of the first moving lens group and a position of the second moving lens group.

8. The zoom lens according to claim 1, wherein the linear magnetic drive structure comprises:
a motor guide rail provided at the base;
a stator structure provided at the motor guide; and
a mover structure configured to move along the optical axis direction relative to the stator structure,
wherein the moving lens group is provided at the mover structure.

9. The zoom lens according to claim 8, wherein two linear magnetic drive structure are provided, and the two linear magnetic drive structures are respectively driven to connect the first moving lens group and the second moving lens group.

10. An imaging device, comprising the zoom lens according to claim 1.
